(19) United States
(12) Patent Application Publication
(10) Pub. No.: US 2022/0321706 A1
(43) Pub. Date: Oct. 6, 2022

(54) IMAGE FORMING APPARATUS

(71) Applicant: KYOCERA Document Solutions Inc., Osaka (JP)

(72) Inventor: Atsuki ITO, Osaka-shi (JP)

(21) Appl. No.: 17/708,175

(22) Filed: Mar. 30, 2022

(30) Foreign Application Priority Data
Mar. 31, 2021 (JP) 2021-059545

(51) Int. Cl. H04N 1/00; G06F 3/04845; G06F 3/12

(52) U.S. Cl. CPC H04N 1/0044; G06F 3/04845; H04N 1/0048; G06F 3/1208; G06F 3/1256

(57) ABSTRACT

The mode setting unit sets the mode of the display unit to a blind mode. An operation for the mode setting unit to set the mode of the display unit to the blind mode is input to the input unit. The image changing unit changes the mode of the display unit from the normal mode to the blind mode based on the operation input to the input unit, and changes at least one of the color and density of the display image of the display unit according to the blind mode. When an operation for setting the mode of the display unit to the blind mode is input to the input unit, the display unit displays a preview image obtained by changing the image data before the image forming unit forms on the sheet in accordance with the blind mode as the display image of the display screen.

### INCORPORATION BY REFERENCE

This application is based upon and claims the benefit of priority from the corresponding Japanese Patent Application No. 2021-59545 filed on Mar. 31, 2021, the entire contents of which are incorporated herein by reference.

### BACKGROUND

The present disclosure relates to an image forming apparatus.

An image forming apparatus capable of forming an image on a recording medium such as paper is used in various applications. Such image forming apparatus has a function of previewing and displaying, on a display screen, an image to be formed before forming the image on the sheet. By the preview display, an image to be actually formed on the sheet can be confirmed.

However, when the image forming apparatus performs the preview display, if a third person peeks at the preview display, the secret information may be leaked. Therefore, it is considered to selectively display a dummy image instead of a preview image. In this type of image display output device, it is possible to select whether to display an image to be printed as it is or to display a filled dummy image based on an instruction from a user, and when the dummy image is selected, the filled dummy image is displayed at the position of the preview image.

### SUMMARY

The image forming apparatus includes an image forming unit, a display unit, a mode setting unit, an input unit, and an image changing unit.

The image forming unit forms an image on the sheet according to the image data.

The display unit displays a display image on a display screen.

The mode setting unit sets the mode of the display unit to a blind mode.

An operation for the mode setting unit to set the mode of the display unit to the blind mode is input to the input unit.

The image changing unit changes the mode of the display unit from the normal mode to the blind mode based on the operation input to the input unit, and changes at least one of the color and density of the display image of the display unit according to the blind mode.

When an operation for setting the mode of the display unit to the blind mode is input to the input unit, the display unit displays a preview image obtained by changing the image data before the image forming unit forms on the sheet in accordance with the blind mode, as the display image of the display screen.

### BRIEF DESCRIPTION OF THE DRAWINGS

### Brief Description of Drawings

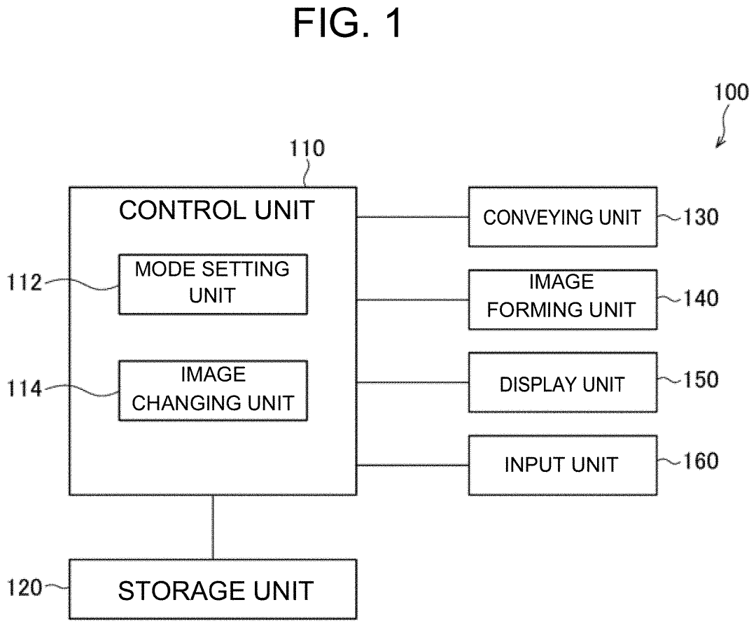

FIG. 1 is a block diagram of an image forming apparatus according to the present embodiment.

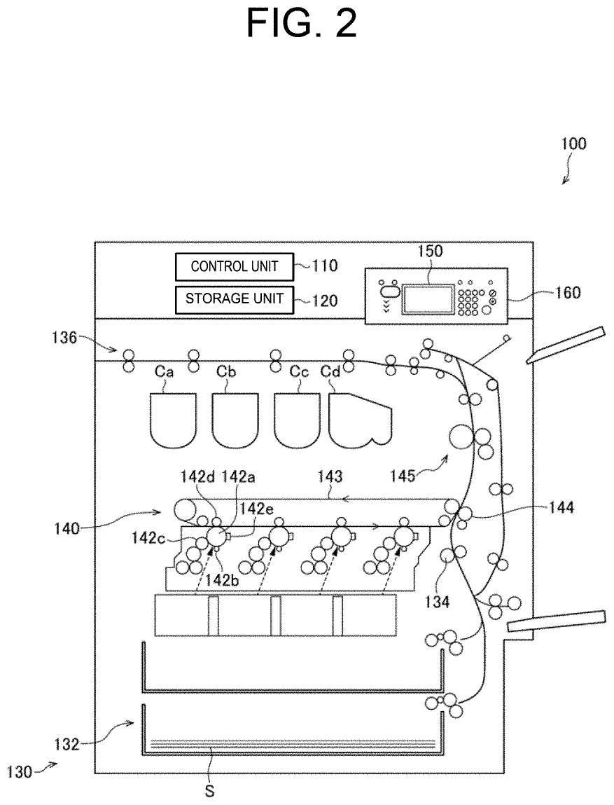

FIG. 2 is a schematic view of an image forming apparatus according to the present embodiment.

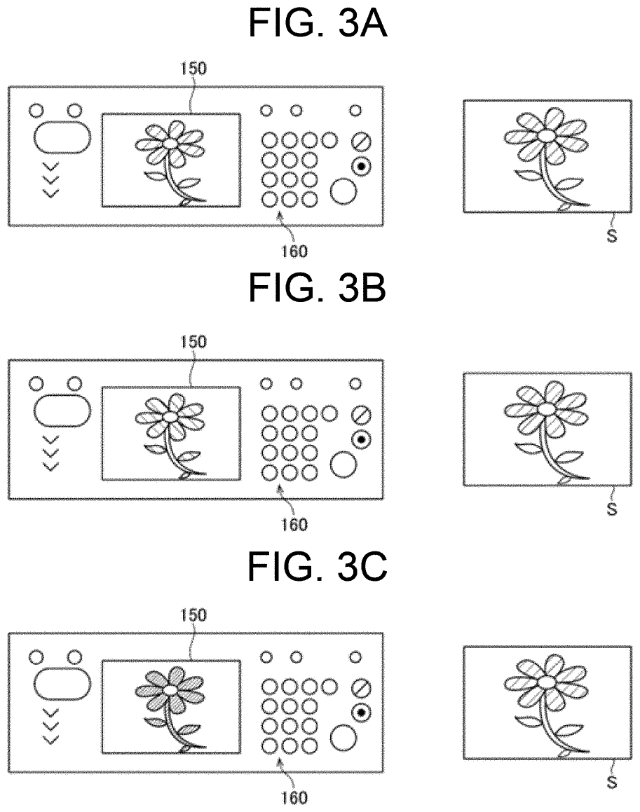

FIG. 3A is a schematic diagram of a display screen for displaying a preview image in a normal mode, FIG. 3B is a schematic diagram of a display screen for displaying a preview image in a blind mode in which colors are changed, and FIG. 3C is a schematic diagram of a display screen for displaying a preview image in a blind mode in which densities are changed.

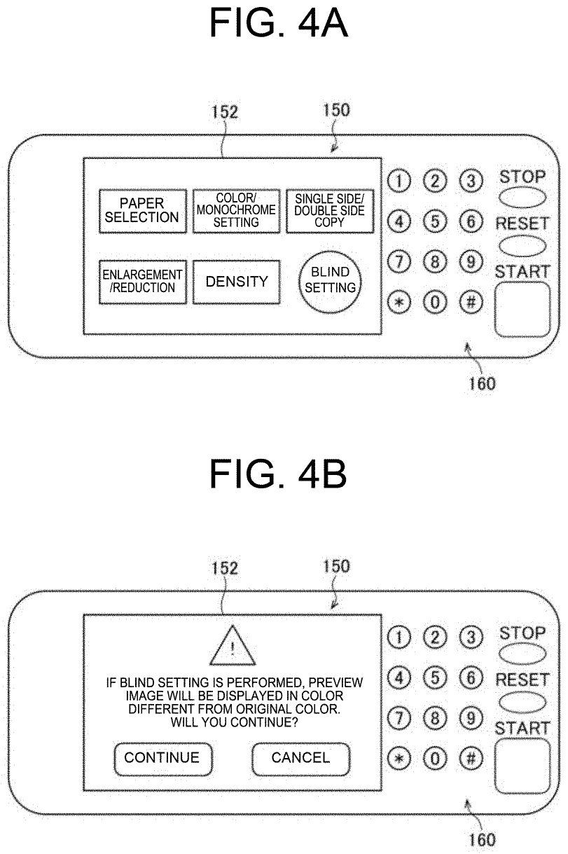

FIGS. 4A and 4B are schematic views showing a display screen of a display unit in the image forming apparatus according to the present embodiment.

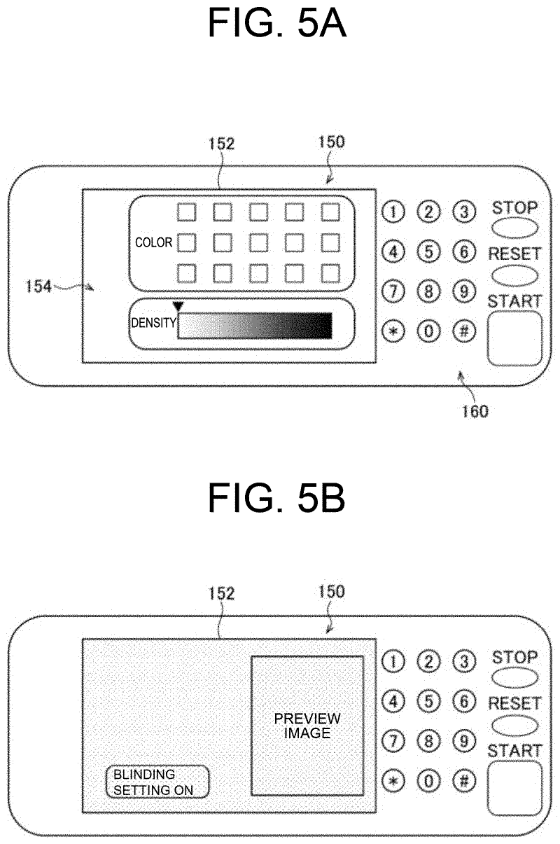

FIGS. 5A and 5B are schematic views showing a display screen of a display unit in the image forming apparatus according to the present embodiment.

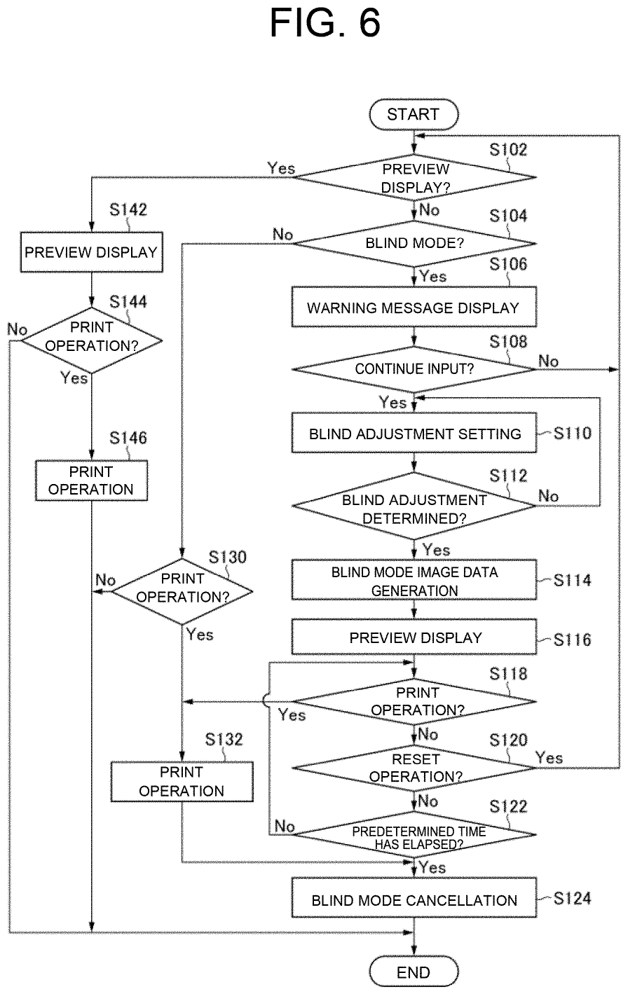

FIG. 6 is an operation flow diagram showing an operation flow of the image forming apparatus according to the present embodiment.

### DETAILED DESCRIPTION

### Embodiment of the Disclosure

Embodiments of the image forming apparatus according to the present disclosure will now be described with reference to the drawings. In the drawings, the same reference numerals are attached to the same or corresponding parts, and the description thereof will not be repeated.

Embodiments of an image forming apparatus and a program according to the present disclosure will now be described with reference to the drawings. In the drawings, the same reference numerals are attached to the same or corresponding parts, and the description thereof will not be repeated.

First, the image forming apparatus 100 of this embodiment will be described with reference to FIG. 1. FIG. 1 is a schematic block diagram of the image forming apparatus 100. The image forming apparatus 100 is, for example, a printer, a copier or a multifunction peripheral. The image forming apparatus 100 may have a facsimile function. The image forming apparatus 100 may be an electrophotographic system or an inkjet system.

The image forming apparatus 100 includes a control unit 110, a storage unit 120, a conveying unit 130, an image forming unit 140, a display unit 150, and an input unit 160. The control unit 110 controls the storage unit 120, the image forming unit 140, the display unit 150, and the input unit 160.

The control unit 110 includes an arithmetic element. The arithmetic element includes a processor. In one example, the processor includes a central processing unit (CPU).

A storage unit 120 stores data and a computer program. The storage unit 120 includes a storage element. The storage unit 120 includes a main storage element, such as a semiconductor memory, and an auxiliary storage element, such as a semiconductor memory and/or a hard disk drive. The storage unit 120 may include removable media. The processor of the control unit 110 executes a computer program stored in the storage element of the storage unit 120 to control each configuration of the image forming apparatus 100.

For example, a computer program is stored in a non-temporary computer readable storage medium. Non-temporary computer readable storage media include a read only memory (ROM), a random access memory (RAM), a CD-ROM, magnetic tape, a magnetic disk, or optical data storage devices.

A storage unit 120 stores image data showing an image. The image data includes page data of one or more pages. The page data indicate images separated for each page.

The conveying unit 130 conveys the sheet S. The conveying unit 130 conveys the sheet S to the image forming unit 140. After the image forming unit 140 forms an image on the sheet S, the conveying unit 130 conveys the sheet S.

An image forming unit 140 forms an image on the sheet S according to the image data. The image forming unit 140 may form an image on the sheet S with toner. Alternatively, the image forming unit 140 may form an image on the sheet S with ink.

A display unit 150 displays an image according to the image data. Therefore, the operator of the image forming apparatus 100 can visually recognize the image data before the image forming unit 140 forms the image on the sheet S.

The display unit 150 includes a liquid crystal display (LCD), an organic EL (Electro Luminescence) display, or a plasma display.

An instruction of an operator is input to an input unit 160. The operator can operate the screen displayed on the display unit 150 by the input unit 160. A user can operate a screen displayed on a display unit 150 by an input unit 160.

The input unit 160 includes a button or a keyboard. Alternatively, the input unit 160 may include a touch sensor. The display unit 150 and the input unit 160 may be a touch panel in which both units are integrated.

A storage unit 120 stores a program for executing the blind mode. By executing the program, the control unit 110 functions as the mode setting unit 112 and the image changing unit 114. Therefore, the image forming apparatus 100 includes a mode setting unit 112 and an image changing unit 114.

A mode setting unit 112 sets the mode of a display unit 150 to a blind mode. In the blind mode, the preview image is displayed in a color (hue) and/or density different from that of the original image.

An input unit 160 accepts an operation for a mode setting unit 112 to set a mode of a display unit 150 to a blind mode.

The image changing unit 114 changes at least one of the color and density of the display image displayed on the display unit 150 according to the blind mode based on the operation received by the input unit 160.

According to the image forming apparatus 100 of the present embodiment, it is possible to prevent the preview image from being peeked by a third person and to prevent an operator from erroneously recognizing the preview image.

Next, an example of the image forming apparatus 100 according to the present embodiment will be described with reference to FIG. 2. FIG. 2 is a schematic view of the image forming apparatus 100. Here, the image forming apparatus 100 is an electrophotographic system.

The conveying unit 130 has a feeding unit 132, a conveying roller 134, and a discharge tray 136.

A feeding unit 132 stores a plurality of sheets S. The sheet S is, for example, a sheet of paper. The feeding unit 132 feeds the sheet S to the conveying roller. The conveying roller conveys the sheet S to the image forming unit 140. The conveying roller includes a plurality of conveying rollers.

Toner containers Ca to Cd are mounted on the image forming apparatus 100. Each of the toner containers Ca to Cd is detachable from the image forming apparatus 100. Toners of different colors are stored in the toner containers Ca to Cd, respectively. The toners of the toner containers Ca to Cd are supplied to the image forming unit 140. An image forming unit 140 forms an image by using the toners from toner containers Ca to Cd.

For example, the toner container Ca stores a yellow toner and supplies the yellow toner to the image forming unit 140. The toner container Cb stores a magenta toner and supplies the magenta toner to the image forming unit 140. The toner container Cc stores a cyan toner and supplies the cyan toner to the image forming unit 140. The toner container Cd stores a black toner and supplies the black toner to the image forming unit 140.

The image forming unit 140 forms an image based on the image data on the sheet S by using the toners stored in the toner containers Ca to Cd. Here, the image forming unit 140 includes an exposure unit 141, a photoreceptor drum 142a, a charging unit 142b, a developing unit 142c, a primary transfer roller 142d, a cleaning unit 142e, an intermediate transfer belt 143, a secondary transfer roller 144, and a fixing unit 145.

The photoreceptor drum 142a, the charging unit 142b, the developing unit 142c, the primary transfer roller 142d, and the cleaning unit 142e are provided corresponding to the toner containers Ca to Cd, respectively. The plurality of photoreceptor drums 142a abut on the outer surface of the intermediate transfer belt 143 and are arranged along the rotational direction of the intermediate transfer belt 143. The plurality of primary transfer rollers 142d are provided corresponding to the plurality of photoreceptor drums 142a. The plurality of primary transfer rollers 142d face the plurality of photoreceptor drums 142a via the intermediate transfer belt 143.

The charging unit 142b charges the peripheral surface of the photoreceptor drum 142a. The exposure unit 141 irradiates each of the photoreceptor drums 142a with light based on the image data, and an electrostatic latent image is formed on the peripheral surface of the photoreceptor drum 142a. The developing unit 142c develops the electrostatic latent image by attaching toner to the electrostatic latent image, and forms a toner image on the peripheral surface of the photoreceptor drum 142a. Therefore, the photoreceptor drum 142a carries the toner image. The primary transfer roller 142d transfers the toner image formed on the photoreceptor drum 142a to the outer surface of the intermediate transfer belt 143. The cleaning unit 142e removes toner remaining on the peripheral surface of the photoreceptor drum 142a.

A photoreceptor drum 142a corresponding to the toner container Ca forms a yellow toner image based on the electrostatic latent image, and a photoreceptor drum 142a corresponding to the toner container Cb forms a magenta toner image based on the electrostatic latent image. The photoreceptor drum 142a corresponding to the toner container Cc forms a cyan toner image based on the electrostatic latent image, and the photoreceptor drum 142a corresponding to the toner container Cd forms a black toner image based on the electrostatic latent image.

On the outer surface of the intermediate transfer belt 143, toner images of a plurality of colors are superposed and transferred from the photoreceptor drum 142a to form an image. Therefore, the intermediate transfer belt 143 carries an image. The intermediate transfer belt 143 corresponds to an example of an “image carrier”. The secondary transfer roller 144 transfers the image formed on the outer surface of the intermediate transfer belt 143 to the sheet S. The fixing unit 145 heats and pressurizes the sheet S to fix the image on the sheet S.

The conveying roller conveys the sheet S on which the image is formed by the image forming unit 140, to the discharge tray 136. The discharge tray 136 discharges the sheet S to the outside of the image forming apparatus 100. The discharge tray 136 includes a discharge roller. The sheet S on which the image is printed by the image forming apparatus 100 is discharged from the discharge tray 136 to the outside of the image forming apparatus 100.

The display unit 150 can display various images. For example, the display unit 150 displays a preview image. The display unit 150 may include a liquid crystal display.

The control unit 110 stores information in the storage unit 120. The control unit 110 reads information from the storage unit 120. If necessary, the control unit 110 erases the information stored in the storage unit 120.

A storage unit 120 stores image data. The storage unit 120 may store image data received via the communication unit 170. For example, image data is received from an external device via communication unit 170 as part of a print job.

An input unit 160 receives an input operation from a user. The input unit 160 may be provided integrally with the display unit 150. The input unit 160 includes a touch panel. The touch panel receives an input operation from the user by detecting the touch of the user.

For example, the input unit 160 receives a print operation from a user. An input unit 160 accepts a preview operation from a user. Alternatively, the input unit 160 receives a print decision operation from a user.

Next, the image forming apparatus 100 according to the present embodiment will be described with reference to FIGS. 1 to 3. FIG. 3A is a schematic diagram of a display unit 150 and an input unit 160 for displaying a preview image in a normal mode, FIG. 3B is a schematic diagram of a display unit 150 and an input unit 160 for displaying a preview image in a blind mode in which colors are changed, and FIG. 3C is a schematic diagram of a display unit 150 and an input unit 160 for displaying a preview image in a blind mode in which densities are changed. FIGS. 3A to 3C show a display unit 150 for displaying a preview image and also show a sheet S on which an image is formed according to the preview image.

As shown in FIG. 3A, when the preview image in the normal mode is displayed, the preview image is displayed according to the image data. In this case, the preview image substantially coincides with the image formed on the sheet S.

As shown in FIG. 3B, when the density is changed in the blind mode, the preview image is changed to an image different from the image according to the original image data. In this case, however, the image formed on the sheet S substantially coincides with the image according to the original image data. Therefore, the preview image displayed in the blind mode is different from the image formed on the sheet S according to the preview image.

As shown in FIG. 3C, when the color is changed in the blind mode, the preview image is changed to an image different from the image according to the original image data. In this case, however, the image formed on the sheet S substantially coincides with the image according to the original image data. Therefore, the preview image displayed in the blind mode is different from the image formed on the sheet S according to the preview image.

According to the present embodiment, in the blind mode, at least one of color and density is changed for an image according to the original image data. Since the preview image displayed in the blind mode is different from the image actually formed on the sheet S, even if a third person views the preview image, the third person cannot recognize the image formed on the sheet S according to the image data. On the other hand, since an image in which at least one of color and density is changed is displayed with respect to an image actually formed on the sheet S, it is possible to prevent an operator from misjudging an image to be operated.

Next, the image forming apparatus 100 according to the present embodiment will be described with reference to FIGS. 1 to 5. FIGS. 4A to 5B are schematic views showing the display screen 152 of the display unit 150 in the image forming apparatus 100 according to the present embodiment.

As shown in FIG. 4A, the display screen 152 displays a plurality of buttons. The plurality of buttons include a blind mode setting button. The plurality of buttons further include a paper selection button, a color/monochrome setting button, a single side/double side setting button, an enlargement/reduction setting button, and a density setting button. The display screen 152 may display a normal preview display button.

As shown in FIG. 4B, when the blind mode setting button is selected, the display screen 152 displays a message warning that at least one of the color and density of the preview image will be changed before displaying the preview image. Here, the display screen 152 displays a continuation button and a cancellation button. When the continuation button is selected, the setting of the blind mode is continued. When the cancellation button is selected, the blind mode setting is canceled.

As shown in FIG. 5A, when the continuation setting button is selected, the display screen 152 is switched to the blind mode setting image for setting the blind mode. In the blind mode setting image, the display screen 152 displays an adjustment unit 154 for adjusting the color and density of the display image in a plurality of stages.

The color of the display image can be adjusted in a plurality of stages in an adjustment unit 154. Further, the density of the display image can be adjusted in a plurality of stages in the adjustment unit 154.

As shown in FIG. 5B, after adjusting the color and/or density of the display image, the display screen 152 displays a preview screen with the color and/or density adjusted. The display screen 152 preferably displays a message indicating that the preview image is displayed in the blind mode even while the preview image is displayed. The preview screen may be formed by adding the color and density adjusted by the adjustment unit 154 to the original image according to the image data.

Next, the image forming apparatus 100 according to the present embodiment will be described with reference to FIGS. 1 to 6. FIG. 6 is an operation flow diagram showing an operation flow of the image forming apparatus 100 according to the present embodiment.

As shown in FIG. 6, in step S104, the control unit 110 determines whether to display the preview image. For example, when the preview display button is selected, the control unit 110 controls the display unit 150 to display the preview image. If the preview image is displayed (Yes in step S102), the process proceeds to step S142. If the preview image is not displayed (No in step S102), the process proceeds to step S104.

In step S104, the mode setting unit 112 determines whether or not to set the blind mode. For example, when the blind mode setting button is selected, the mode setting unit 112 controls the display unit 150 to change the mode of the display unit 150 from the normal mode to the blind mode. If the blind mode is set (Yes in step S104), the process proceeds to step S106. If the blind mode is not set (No in step S104), the process proceeds to step S130.

In step S106, the display unit 150 displays a warning message. The control unit 110 controls the display unit 150 so that the display unit 150 displays a warning message indicating that at least one of the color and density of the preview image is changed.

In step S108, the mode setting unit 112 determines whether or not an instruction indicating continuation of the blind mode has been input to the input unit 160. For example, when the continuation button is selected, the mode setting unit 112 controls the display unit 150 so that the blind mode continues. If an instruction indicating continuation of the blind mode is input (Yes in step S108), the process proceeds to step S110. If no instruction indicating continuation of the blind mode is input (No in step S108), the process returns to step S102.

In step S110, the display unit 150 displays the blind mode setting image to set the adjustment of the blind mode. The control unit 110 controls the display unit 150 so that the display unit 150 displays the blind mode setting image.

In step S112, the control unit 110 determines whether or not the blind mode adjustment has been determined. For example, if the start button is pressed after at least one of the color and density of the image is changed in the blind mode setting image, the control unit 110 determines that the adjustment of the blind mode has been determined. When the blind mode adjustment is determined (Yes in step S112), the process proceeds to step S114. When the blind mode adjustment is not determined (No in step S112), the process returns to step S110.

In step S114, the image changing unit 114 changes at least one of the color and density of the display image displayed on the display unit 150 in accordance with the blind mode to generate blind mode image data. A control unit 110 generates blind mode image data according to the setting of the blind mode and the image data.

In step S116, the display unit 150 displays the preview image according to the blind mode image data. The control unit 110 controls the display unit 150 so as to display an image according to the blind mode image data.

In step S118, the control unit 110 determines whether to print the image data. For example, when the start button is pressed, the control unit 110 controls the conveying unit 130 and the image forming unit 140 to form an image on the sheet S according to the image data. If printing is performed according to the image data (Yes in step S118), the process proceeds to step S132. If printing is not performed according to the blind mode image data (No in step S118), the process proceeds to step S120.

In step S120, the control unit 110 determines whether or not to reset the blind mode image data. For example, when the reset button is pressed, the control unit 110 erases the blind mode image data. When the blind mode image data is reset (Yes in step S120), the process returns to step S102. If the blind mode image data is not reset (No in step S120), the process proceeds to step S122.

In step S122, the control unit 110 determines whether or not a predetermined time has elapsed. For example, the control unit 110 determines whether a predetermined time has elapsed since the display unit 150 displayed the preview image according to the blind mode image data. When the predetermined time has elapsed (Yes in step S122), the process proceeds to step S124. When the predetermined time has not elapsed (No in step S122), the process returns to step S1118.

In step S124, the control unit 110 cancels the setting of the blind mode and deletes the blind mode image data. Thereafter, the process ends.

In step S130, the control unit 110 determines whether to print the image data. For example, when the start button is pressed, the control unit 110 controls the conveying unit 130 and the image forming unit 140 to form an image on the sheet S according to the image data. When printing is performed according to the image data (Yes in step S130), the process proceeds to step S132. When printing is not performed according to the image data (No in step S130), the process ends.

In step S132, the image forming unit 140 forms an image on the sheet S according to the image data. The control unit 110 controls the image forming unit 140 so that the image forming unit 140 forms an image on the sheet S according to the original image data. The process then proceeds to step S124.

In step S142, the display unit 150 displays the display image according to the image data. The control unit 110 controls the display unit 150 so that the display unit 150 displays the display image according to the image data.

In step S144, the control unit 110 determines whether to print the image data. For example, when the start button is pressed, the control unit 110 controls the conveying unit 130 and the image forming unit 140 to form an image on the sheet S according to the image data. When printing is performed according to the image data (Yes in step S144), the process proceeds to step S146. When printing is not performed according to the image data (No in step S144), the process ends.

In step S146, the image forming unit 140 forms an image on the sheet S according to the image data. The control unit 110 controls the image forming unit 140 so that the image forming unit 140 forms an image on the sheet S according to the image data. Thereafter, the process ends.

As described above, according to the image forming apparatus of the present embodiment, while the display screen in which at least one of the color and density of the image is adjusted based on the blind mode image data is displayed according to the blind mode, when the image data is printed, the image can be formed on the sheet according to the original image data. Therefore, it is possible to prevent a third person from peeking at the preview image and to prevent an operator from erroneously recognizing the preview image.

Embodiments of the present disclosure have been described with reference to the drawings. However, the present disclosure is not limited to the above-described embodiments, and can be implemented in various modes without departing from the gist thereof. In addition, various disclosures can be formed by appropriately combining a plurality of components disclosed in the above embodiments. For example, some components may be removed from all components shown in the embodiments. In addition, components across different embodiments may be suitably combined. The drawings schematically show the respective components mainly for the purpose of easy understanding, and the thickness, length, number, spacing, etc. of the illustrated components may be different from the actual ones for the convenience of drawing preparation. The materials, shapes, dimensions, etc. of the respective components shown in the above embodiments are only examples, and are not particularly limited, and various changes are possible within a range not substantially deviating from the effects of the present disclosure.

What is claimed is:

1. An image forming apparatus comprising:
an image forming unit that forms an image on a sheet according to image data;
a display unit that displays a display image on a display screen;
a mode setting unit that sets a mode of the display unit to a blind mode;
an input unit to which an operation for the mode setting unit to set the mode of the display unit to the blind mode is input; and
an image changing unit that changes the mode of the display unit from a normal mode to the blind mode based on the operation input to the input unit, and changes at least one of a color and a density of the display image of the display unit according to the blind mode, wherein
when an operation for setting the mode of the display unit to the blind mode is input to the input unit, the display unit displays a preview image obtained by changing the image data before the image forming unit forms on the sheet in accordance with the blind mode, as the display image of the display screen.

2. The image forming apparatus according to claim 1,
wherein before the display unit displays the preview image on the display screen, the display unit displays a message warning that at least one of a color and a density of the preview image has been changed.

3. The image forming apparatus according to claim 1,
wherein when an operation for setting the mode of the display unit to the blind mode is input to the input unit, the display unit changes the display image on the display screen to a blind mode setting image for setting the blind mode.

4. The image forming apparatus according to claim 3,
wherein the display unit displays an adjustment unit for adjusting the color and the density of the display image of the display unit in a plurality of stages in the blind mode setting image.

5. The image forming apparatus according to claim 1,
wherein after the image forming unit forms the image on the sheet, the mode setting unit returns the mode of the display unit from the blind mode to the normal mode.
